(19) United States
(12) Patent Application Publication
(10) Pub. No.: US 2010/0272080 A1
(43) Pub. Date: Oct. 28, 2010

(54) Techniques for generating proof of WiMAX activation and safely handling a disconnect during a WiMAX provisioning session

(76) Inventors: Eetay Natan, Ramat Gan (IL); Danny Moses, Petach Tikva (IL)

Correspondence Address: INTEL CORPORATION;c/o CPA Global, P.O. BOX 52050, MINNEAPOLIS, MN, 55402, US

(21) Appl. No.: 12/386,879

(22) Filed: Apr. 24, 2009

(51) Int. Cl. H04W 4/00

(52) U.S. Cl. 370/338

(57) ABSTRACT

An embodiment of the present invention provides a method, comprising using actual values inside an Open Mobile Alliance Device Management (OMA DM) activation session to produce a unique combination of values for a mobile device operable in a wireless network to verify activation by a certain network service provider (NSP).

### BACKGROUND

Retail activation of devices operable in wireless networks, such as, but not limited to, those operating in conformity with the Institute for Electronic and Electrical Engineers (IEEE) 802.16 (WiMAX) standard, is made possible by pushing parameters from WiMAX networks to the WiMAX devices (e.g., but not limited to, notebook or mobile stations (MS)) via a special provisioning session between WiMAX networks and WiMAX devices, which use the OMA DM protocol (referred to herein as an ‘OMA DM session’ as seen in FIG. 1, generally as 100). FIG. 1 shows the general form of an OMA DM session in accordance with one embodiment of the present invention in which a DM client is illustrated at 110 and DM server is shown at 120 with the session of package 1-package 4 communication shown therebetween. Those parameters concerning the subscription vary between network service providers (NSPs) depending on the WiMAX subscriber authentication method used by each particular NSP and the scheme used by NSP to manage its subscribers.

Because parameters vary from one NSP to another, the WiMAX device software/firmware cannot provide a trusted proof that a WiMAX activation was indeed performed by a certain NSP on that WiMAX device. Providing such a proof means the WiMAX device is able to produce some information it could not have, unless it was actually activated, which can be verified by a NSP. Such a proof is useful for business reasons, such as audits or dispute resolution (for example in activation revenue share between a device manufacturer and NSP).

The WiMAX standard defines over the air provisioning using an OMA DM (a certain standard protocol from the Open Mobile Alliance) session where WiMAX device's provisioning information is sent over the RF by WiMAX carrier (NSP)'s provisioning server into the WiMAX device. It is important to note that some parts of the provisioning information are tightly coupled together (example: user-name and password), and must be applied together to maintain consistency on the WiMAX device.

However, the OMA DM provisioning server (according to the OMA DM standard) sends each parameter and receives ACKnowledge for it, separately. Overcoming this problem is simple: To prevent applying partial information, most devices, and in particular WiMAX devices, apply the provisioning information only at the end of a successful DM session. The above implementation creates the following potential problem: a failure in the connectivity (RF, IP or otherwise) occurring during the OTA provisioning session where device has not applied the information, but has already ACK'ed what was pushed by OMA DM server till the disconnect, leads the network's OMA DM provisioning server to believe that certain information is already provisioned on the device while it is actually lost. This in turn means the OMA DM provisioning server will not push that provisioning information again, resulting in failure to provision the device automatically, since OMA OM server and client cannot recover in this case without some external trigger, such as user reset.

Thus, there is an important need for techniques for generating proof of wireless network activation and safely handling a disconnect during a network provisioning session.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a general form of an OMA DM session in accordance with one embodiment of the present invention; and

FIGS. 2A and 2B is a WiMAX OMA DM tree concerning provisioning in accordance with one embodiment of the present invention.

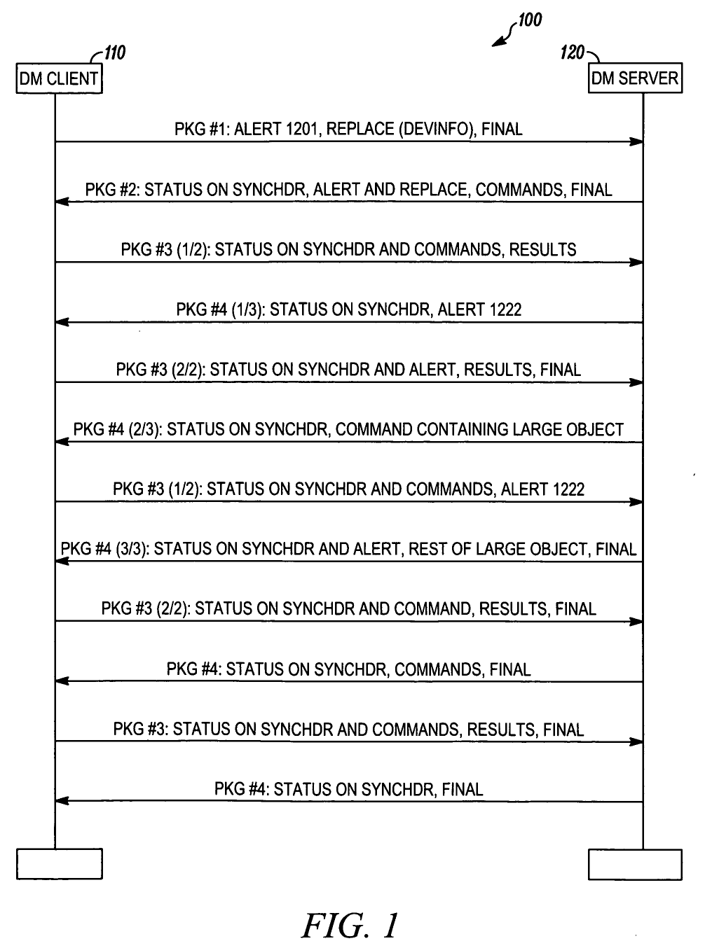

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art. In some embodiments, such algorithms and data processing may include analog processing at baseband frequencies, intermediate-frequencies (IF), or radio-frequencies (RF) implemented at least in part in hardware, in software, or in a combination thereof, although the scope of the invention is not limited in this respect.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as processing, computing, calculating, determining, or the like, refer to the action or processes of a computer or computing system, or similar electronic computing device, that manipulate or transform data represented as physical, such as electronic, quantities within the registers or memories of the computing system into other data similarly represented as physical quantities within the memories, registers or other such information storage, transmission or display devices of the computing system.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), flash memory, magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Embodiments of the present invention provide using actual values inside the WiMAX OMA DM activation session itself, to produce a unique combination of values the WiMAX device would find very hard to put together (de-facto would not have otherwise been able to produce), unless it was actually activated. Thus, the WiMAX device will be able to prove it was activated by a certain network service provider (NSP). More specifically, embodiments of the present invention provide using those values from DM commands and manipulating the DM tree's parameters concerning the subscriber setup and the authentication setup. These commands within the session can be detected by the OMA DM tree path as follows (it is understood that this particular tree path is merely illustrative):

```
<SyncML xmlns=‘SYNCML:SYNCML1.2’>
  <SyncHdr>
    <VerDTD>1.2</VerDTD>
    <VerProto>DM/1.2</VerProto>
    <SessionID>1</SessionID>
    <MsgID>1</MsgID>
    <Target>
      <LocURI>http://www.syncml.org/mgmt-server</LocURI>
    </Target>
    <Source>
      <LocURI>IMEI:493005100592800</LocURI>
    </Source>
    <Cred> <!-- Client credentials are mandatory if the transport layer is
    not providing authentication.-->
      <Meta>
        <Type xmlns=“syncml:metinf”>syncml:auth-basic</Type>
        <Format xmlns=‘syncml:metinf’>b64</Format>
      </Meta>
      <Data>
        <!-- base64 formatting of userid:password -->
      </Data>
    </Cred>
    <Meta> <!-- Maximum message size for the client -->
      <MaxMsgSize xmlns=“syncml:metinf”>5000</MaxMsgSize>
    </Meta>
  </SyncHdr>
  <SyncBody>
    <Alert>
      <CmdID>1</CmdID>
      <Data>1200</Data> <!-- Server-initiated session -->
    </Alert>
    <Replace>
      <CmdID>3</CmdID>
      <Item>

[symbol]

        <Meta>
          <Format xmlns=‘syncml:metinf’>chr</Format>
          <Type xmlns=‘syncml:metinf’>text/plain</Type>
        </Meta>
        <Data>IMEI:493005100592800</Data>
      </Item>
      <Item>
        <Source><LocURI>./DevInfo/Man</LocURI></Source>
        <Meta>
          <Format xmlns=‘syncml:metinf’>chr</Format>
          <Type xmlns=‘syncml:metinf’>text/plain</Type>
        </Meta>
        <Data>Device Factory, Inc.</Data>
      </Item>
    </Replace>
    <Final/>
  <SyncBody>
</SyncML> [symbol]
indicates data missing or illegible when filed
```

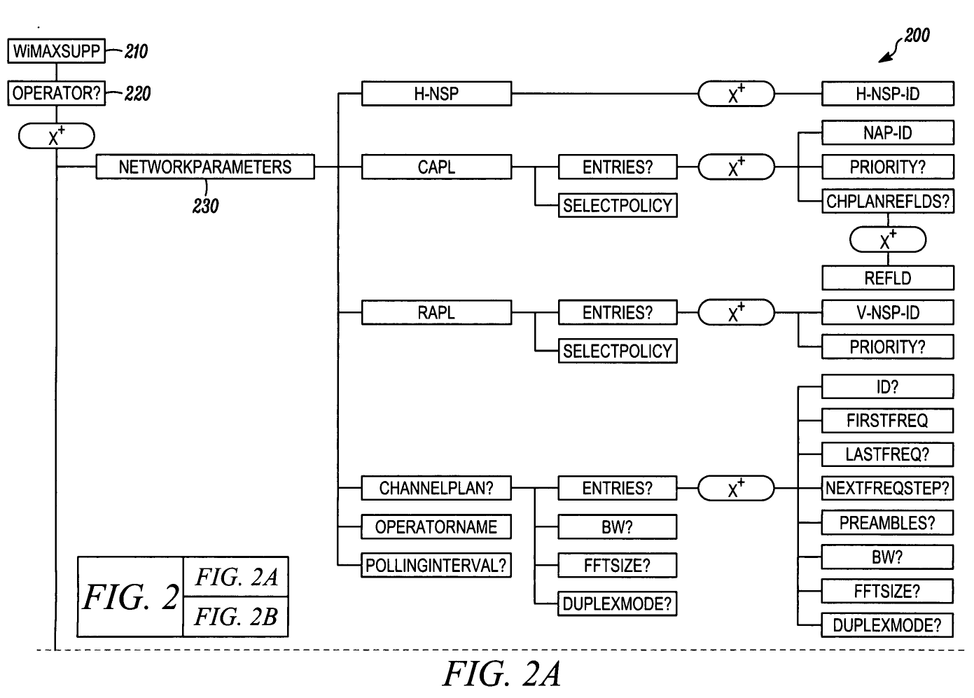

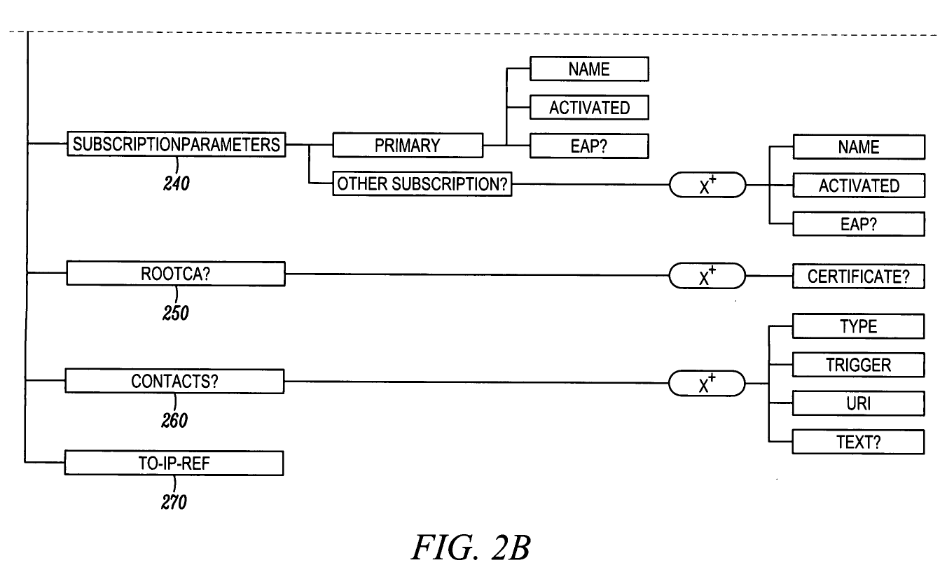

This is specified according to the WiMAX forum standard for the OMA DM session and parameters for over-the-air (OTA) provisioning which is depicted generally as 200 of FIGS. 2A and 2B. It is understood that that as the WiMAX standard develops and progresses, the present FIGS. 2A and 2B may undergo changes and thus FIGS. 2A and 2B are depicted herein as merely an exemplary embodiment for purposes of fully describing one implementation of the present invention. The logical branches (objects, functionality) of 210-270 will still be present in all implementations; however, the exact structure of the tree may vary and these variations are intended be to within the scope of the present invention. Embodiments of the WiMAX embodiment of the present invention may include top level tree components comprising: WiMAXSupp 210; Operator 220; NetworkParameters 230; SubscriptionParameters 240; RootCA 250; Contacts 260; and TO-IP-REF 270.

The following values may be taken from OMA DM session according to embodiments of the present invention:

DM server parameters, such as IP address;

The Session IDs of the DM session where provisioning the authentication parameters occurred; and

The Message IDs of the DM message(s) inside the DM session, containing the provisioning commands of the authentication parameters.

Further embodiments of the present invention provide safely handling a disconnect during a wireless network, such as WiMAX wireless network, provisioning session.

### Components of Embodiments of the Present Invention may Include

Mobile Station (MS)—The WiMAX device; Notebook, MID or otherwise with a WiMAX modem and WiMAX stack, including OMA DM client;

OMA DM provisioning server—The server on the WiMAX core network side, responsible for provisioning the WiMAX device;

(current) OMA DM tree—a database held on WiMAX device side that holds the active provisioning information. OMA DM server request modifications to this database during WiMAX provisioning, but changes are only applied at certain times by MS; and

(new) OMA DM tree—Embodiments of the present invention define a copy of the current OMA DM database. This copy is held on the WiMAX device side and holds the very latest provisioning information. This database is changed on the fly by the OMA DM server during OMA DM session.

In operation, embodiments of the present invention provide that whenever an OMA DM server establishes a session with Mobile Station (MS), the MS interacts with OMA OM server as per the WiMAX OTA specification and OMA DM standard. The changes made by OMA DM server to provisioning information are recorded by the MS (i.e. the MS keeps an updated copy of OMA DM tree, with all the new information pushed by OMA DM server).

The information is applied when the OMA DM session completes successfully. The MS replaces the current OMA DM tree with the new updated OMA DM tree. If the OMA DM session does not complete successfully, the new OMA DM tree copy is stored aside (e.g. in disk), but does not change the current OMA DM tree.

When a new OMA DM session is created, the OMA DM tree reflected to the OMA DM server is the new OMA DM tree (includes the modifications from last session which did not complete). The OMA DM server can continue modifying the new OMA DM tree. This process may be repeated depending on if the OMA session completes successfully or not.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We claim:

1. A method, comprising:
using actual values inside an Open Mobile Alliance Device Management (OMA DM) activation session to produce a unique combination of values for a mobile device operable in a wireless network to verify activation by a certain network service provider (NSP).

2. The method of claim 1, wherein said wireless network operates conforming to the Institute for Electronics and Electrical Engineers (IEEE) 802.16 (WiMAX) standard.

3. The method of claim 2, further comprising using values from DM commands and manipulating said DM tree's parameters concerning a subscriber setup and authentication setup.

4. The method of claim 3, wherein said DM commands within said session are detected by an OMA DM tree path specified according to said WiMAX standard for said OMA DM session and parameters for over-the-air (OTA) provisioning.

5. The method of claim 4, wherein the following values are taken from said OMA DM session: DM server parameters, including an IP address; Session IDs of said DM session where provisioning the authentication parameters occurred; Message IDs of said DM message(s) inside said DM session, containing the provisioning commands of the authentication parameters; and
wherein the combination of any or all of said values is a unique number per NSP for a particular WiMAX device identity and a specific time/date.

6. The method of claim 5, wherein said WiMAX device identity is a MAC address and thus said WiMAX device or anyone other than NSP cannot readily derive a complete combination without actually having access to a real activation session on said WiMAX device.

7. A method for safely handling a disconnect during WiMAX provisioning sessions, comprising:
establishing a session, by an OMA DM server, with a Mobile Station (MS), wherein said MS interacts with said OMA DM server such that changes made by said OMA DM server to provisioning information are recorded by said MS; and
applying said provisioning information when said OMA DM session completes successfully by said MS replacing a current OMA DM tree with a new updated OMA DM tree and if said OMA DM session does not complete successfully, a new OMA DM tree copy is stored aside, but does not change said current OMA OM tree.

8. The method of claim 7, wherein when a new OMA DM session is created, said OMA DM tree reflected to said OMA DM server is said new OMA DM tree, which includes modifications from a last session which did not complete, and whereafter said OMA DM server continues modifying said new OMA DM tree.

9. The method of claim 7, wherein the interaction between said MS and said OMA DM server is according to an institute for Electronic and Electrican engineers (IEEE) 802.16 (WiMAX) OTA specification and OMA DM standard.

10. The method of claim 9, wherein said recording by said MS is accomplished by said MS keeping an updated copy of said OMA DM tree, with all new information pushed by said OMA DM server.

11. An apparatus, comprising:
a mobile device operable in a wire less network and using actual values inside an Open Mobile Alliance Device Management (OMA DM) activation session to produce a unique combination of values for said mobile device to verify activation by a certain network service provider (NSP).

12. The apparatus of claim 11, wherein said wireless network operates conforming to the Institute for Electronics and Electrical Engineers (IEEE) 802.16 (WiMAX) standard.

13. The apparatus of claim 12, wherein said mobile device uses values from DM commands and manipulates said DM tree's parameters concerning a subscriber setup and authentication setup.

14. The apparatus of claim 13, wherein said DM commands within said session are detected by an OMA DM tree path specified according to said WiMAX standard for said OMA DM session and parameters for over-the-air (OTA) provisioning.

15. The apparatus of claim 14, wherein the following values are taken from said OMA DM session: DM server parameters, including an IP address; Session IDs of said DM session where provisioning the authentication parameters occurred; Message IDs of said DM message(s) inside said DM session, containing the provisioning commands of the authentication parameters; and
wherein the combination of any or all of said values is a unique number per NSP for a particular WiMAX device identity and a specific time/date.

16. The apparatus of claim 15, wherein said WiMAX device identity is a MAC address and thus said WiMAX device or anyone other than NSP cannot readily derive a complete combination without actually having access to a real activation session on said WiMAX device.

17. A apparatus, comprising:
a mobile station configured to establish a session, by an OMA DM server, with said Mobile Station (MS), wherein said MS interacts with said OMA DM server such that changes made by said OMA DM server to provisioning information are recorded by said MS; and
wherein said MS applies said provisioning information when said OMA DM session completes successfully by said MS replacing a current OMA DM tree with a new updated OMA DM tree and if said OMA DM session does not complete successfully, a new OMA DM tree copy is stored aside, but does not change said current OMA OM tree.

18. The apparatus of claim 17, wherein when a new OMA DM session is created, said OMA DM tree reflected to said OMA DM server is said new OMA DM tree, which includes modifications from a last session which did not complete, and whereafter said OMA DM server continues modifying said new OMA DM tree.

19. The apparatus of claim 17, wherein the interaction between said MS and said OMA DM server is according to an institute for Electronic and Electrican engineers (IEEE) 802.16 (WiMAX) OTA specification and OMA DM standard.

20. The apparatus of claim 19, wherein said recording by said MS is accomplished by said MS keeping an updated copy of said OMA DM tree, with all new information pushed by said OMA DM server.
